(19) United States
(12) Patent Application Publication
(10) Pub. No.: US 2002/0110285 A1
(43) Pub. Date: Aug. 15, 2002

(54) Method for internet browser-based digital image capture and management system

(76) Inventors: Douglas W. Wang, Hsinchu (TW); Yu-Chang Chang, Hsinchu (TW); Wei-Shang Chen, Taichung (TW); Lin-Chu Weng, Hsinchu (TW); Yao-Lung Tsai, Hoping (TW)

Correspondence Address: BAKER & BOTTS, 30 ROCKEFELLER PLAZA, NEW YORK, NY, 10112

(21) Appl. No.: 09/836,097

(22) Filed: Apr. 17, 2001

(30) Foreign Application Priority Data
Feb. 15, 2001 (TW) 90103483

(51) Int. Cl. G06K 9/54; G06K 9/60; G06K 9/03

(52) U.S. Cl. 382/305; 382/309

(57) ABSTRACT

A method and system for managing a digital image using online driving from a network are disclosed. A digital image is formed by a capturing device and then is stored in a first memory of the capturing device. Afterwards, a program media automatically diagnoses the capturing device and then installs a driver corresponding to the capturing device for online driving of the capturing device. The digital image in the first memory is uploaded to a second memory of the image server, and therefore the capacity of the first memory is completely released. Thereafter, the digital image is properly edited and is stored in the second memory to manage and distribute with respect to the digital image. Finally, a remote PC is linked to the image server via the Internet for selectively downloading the digital image saved in the secondary memory.

### FIELD OF THE INVENTION

The present invention generally relates to a method and system for managing images using online driving from a network, and more particularly, to an image server constructed in an image management system for transferring digital images acquired by a capturing device from the Internet. The image management system is able to solve capturing device's lack of memory capacity and at the same time provides the digital image with management and distribution.

### BACKGROUND OF THE INVENTION

With the rapid developments of computer and network technique in recent years, consumer electronic products are becoming more and more widespread, particularly, the digital camera. The digital camera has many improvements over the conventional camera. For example, the conventional camera is unable to immediately display an image after a picture is taken because it must be developed first. Thus, the conventional camera is, in terms of efficiency, mediocre compared to the digital camera. Furthermore, the conventional camera is more frequently used, so the cost of developing a great deal of new film is very high.

Generally, the conventional camera applies some types of memory media, such as compact flash cards, smart media cards and floppy disks, used to store image data. Thereafter, a universal serial bus (USB) or serial port is utilized to transfer image data into a personal computer (PC). Finally, a specific capture driver must be set for the purpose of driving the capturing device. However, the media's memory capacity is limited due to it only having 16 Mbytes, 32 Mbytes or 64 Mbytes. Moreover, the memory cards expense is too big and a uniform specification does not exist so that the change of memory cards will result in a maintenance difficulty.

In addition, since the enlargement of the digital camera's recording modes, the file size of the image will greatly increase. Nevertheless, the current related techniques are effectively unable to overcome the memory cards shortcoming. Therefore, the memory cards of the digital camera do not meet the requirement. Additionally, the conventional digital camera usually has four types of still resolution, 640×480, 1280×960, 1600×1200, and 2048×1536 or higher, so it occupies a large amount of memory. Moreover, when a moving picture is recorded, the additional animation effects, zero distortion compression, and voice recording also takes up a large amount of memory. As well as a high-capacity requirement will considerably increase, especially, for home page design, personal digital assistant (PDA) and mobile phones and similar applications.

Consequently, processing film is not economical, actually it is very expensive to develop film. The media's memory capacity is severely limited. Moreover, the cost of memory cards is too high. Currently a uniform specification does not exist either, so as a result providing maintenance to change of the memory cards will be difficult.

### SUMMARY OF THE INVENTION

In view of the problems encountered in the conventional digital camera, the primary objective of the present invention is to provide a large amount of memory capacity for storing the digital image data.

Another objective of the present invention is to make use of the imaging server's program media for managing and distributing the digital image whenever and wherever the Internet network is accessed.

Still another objective of the present invention is that the imaging server's driving media is used for driving the capture online via a network to increase the convenience of the digital image transmission.

According to the above objectives, the present invention sets forth a method and system for managing digital images using online driving from the network. Firstly, a digital image is formed by a capturing device, wherein the digital image is stored in a first memory of the capturing device, and a local personal computer (PC) makes a real-time connection to an Internet network and receives the digital image. Thereafter, an image server performs an authorization check and then gives an access right to the user for increasing the operation security, wherein the image sever has been connected to Internet network.

Afterwards, a program media automatically diagnoses the capturing device and then installs a driving media corresponding to the capturing device's online driver to increase transmission convenience with respect to the capturing device. The digital image stored in the first memory is uploaded to a second memory of the image server, and therefore the capacity of the first memory is completely released. The digital image stored in the image server is properly edited and is stored in the second memory to promote the efficiency of the first memory, namely for managing and distributing the image with respect to the digital image. Finally, a remote PC selectively downloads the digital image saved in the secondary memory.

A system for managing digital images using online driving from a network comprises a capturing device, a local PC, an image server, and a remote PC. The capturing device, having a first memory and a transmission device, acquires digital images and then stores them in the first memory. A local PC, coupled to the capturing device and the Internet, utilizes a local PC's communication port connected to the transmission device to receive the digital image.

In addition, the image server, coupled to the local PC via the Internet, comprises of a second memory, a driving media, a program media, and an image-processing device. The second memory supplies a sufficient amount of memory as temporary storage to save the digital image. The driving media provides a variety of drivers responsive to the capturing device respectively. The program media diagnoses the capturing device and then installs the driver to drive the capturing device by Internet. The image-processing device edits the second memory's digital image to perform management and distribution with respect to the digital image. A remote PC connects to the image server via the Internet for selectively downloading the digital image stored in the secondary memory.

In summary, the present invention is to provide a method and system for managing digital images using online driving from a network. The image server provides a large amount of memory so as to store digital images. Additionally, the user can easily perform the default management program to distribute the digital image whenever and wherever the Internet network is accessed. It is more beneficial that the image server drives the capturing device online by using a proper driver and the memory of the capturing device has been kept available at all times.

### BRIEF DESCRIPTION OF THE DRAWINGS

The foregoing aspects and many of the attendant advantages of this invention will become more readily appreciated and become better understood by reference to the following detailed description, when taken in conjunction with the accompanying drawings, wherein:

FIG. 1 illustrates a flow chart of a preferred embodiment according to the present invention; and

FIG. 2 illustrates a system diagram of a preferred embodiment according to the present invention.

### DETAILED DESCRIPTION OF THE PREFERRED EMBODIMENTS

The present invention is directed to a method and system for managing digital images using online driving from a network to improve the drawbacks of the prior art.

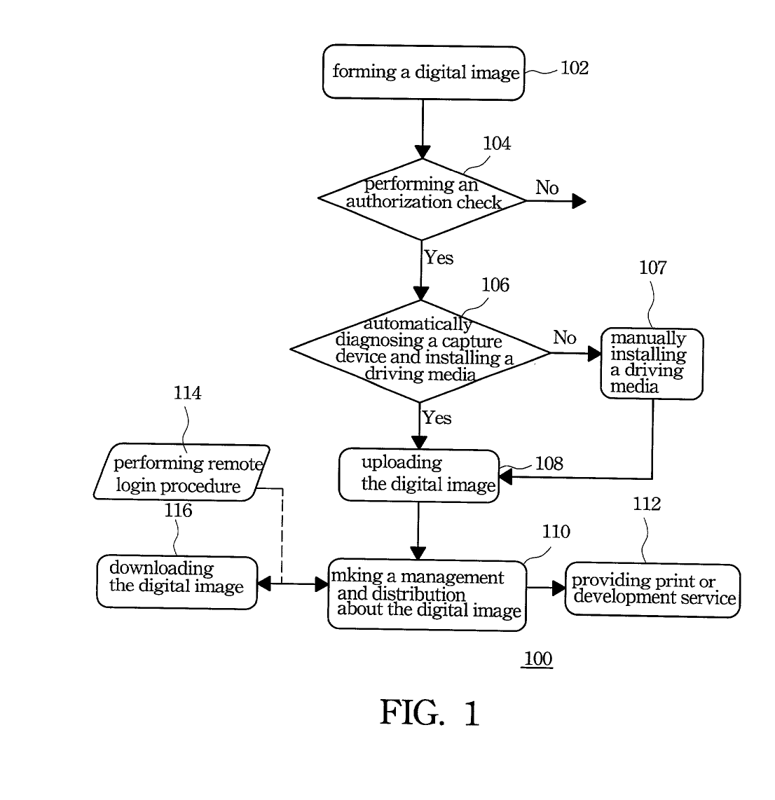

Referring to FIG. 1, a flow chart 100 of a preferred embodiment according to the present invention. In step 102, a capturing device forms the digital image and then it's stored in the first memory of the capturing device. A local PC can make a real-time connection to the Internet and receive the digital image. In the preferred embodiment of the present invention, a specific digital image taken by the digital camera or a still picture acquisition from moving film formed by a PC camera is saved in the first memory, such as compact flash cards, smart media cards and floppy disk.

In step 104, an image server carries out a user authorization check by using a default program therein and then offers an access right to users so as to increase the operational security, wherein the image sever has been connected to the network.

In step 106, the image server automatically performs the program media to instantly diagnose the capturing device and installs driving media corresponding to the capturing device's memory, wherein the driving media includes several kinds of drivers corresponding to the capturing device. If step 107 proceeds, a proper driver is manually selected from driving media and is installed to drive the capturing device.

When management or distribution is in operation, the user just utilizes a PC coupled with the image server by a network, and thus the program media is able to select a kind of driver responsive to the capturing device from the driving media. In the preferred embodiment of the present invention, the program media can identify the capturing device by using common gate interface (CGI), active server page (ASP), hypertext markup language (HTML), extensible markup language (XML), Java or any one of the above combinations. The program media may be run on browser, such as Internet explore (IE), and is capable of identifying the type of the capturing device, simultaneously providing a kind of driver responsive to the capturing device wherein the driver is preferably installed in the image server or the local PC.

Java application programs have a lot of features, e.g. cross-platform and object-oriented programming (OOP). In other words, the Java application program can be performed in various kinds of devices, such as PC, MAC, PDA, mobile phone and information appliances (IA), and other operation system (OS), e.g. UNIX, NT and Windows series products. In addition, the Java application program has functions, such as network connection, information sharing and interactive communication, such that the image server can automatically identify the capturing device by the Java application program.

Specifically, the Java application program serves as a distribution computation so that the application program is performed not only in one computer but also in others according to the operation contents to promote the computation efficiency.

In step 108, users upload the digital image stored in the first memory to the second memory of the image server, and thus the capacity of the first memory is completely released. In other embodiments of the present invention, the digital image in the first memory is temporarily stored in the local PC's media memory. Thereafter, the digital image is transmitted to the second memory of the image server. After the digital camera's memory capacity is entirely available, the digital camera can continuously proceed the sequent image-acquired process to solve the lack of memory media.

When one travels for an extended period, having enough available memory in the image server is important. It serves as a solution for having to buy additional memory because of the many digital images that will be acquired. When the digital camera or PC camera is couple with the image server, the user will transfer the digital image stored in the first memory of the capturing device to the second memory of the image sever. Most importantly, the user can selectively allocate the size of the memory according the requirement.

In step 110, the image server implements the management and distribution. In the preferred embodiment, a proper image editing software, such as “Cutephoto” software, is installed in the image server for the capturing device. There are many processes comprising classification, editing, copying, removing, previewing, and transmitting. Afterwards, the digital image-processed is directly stored in the large memory, e.g. primitive hard disks, of the image server. In step 112, the image server also provides the service, e.g. printing or developing, to output the digital image to papers after the digital image has been processed. Namely, the user utilizes the image server connected to the printing device via a network and selects the desired service to obtain benefits of timesaving and convenient manipulation. Alternatively, the image server has the memory capacity to substitute the memory media of the digital camera, and employs complete management and distribution with the digital image.

In step 114, a remote PC user must be authorized when they login to the image server to get information. In step 116, the user downloads the digital image stored in the second memory of the image server to the remote PC by Internet network.

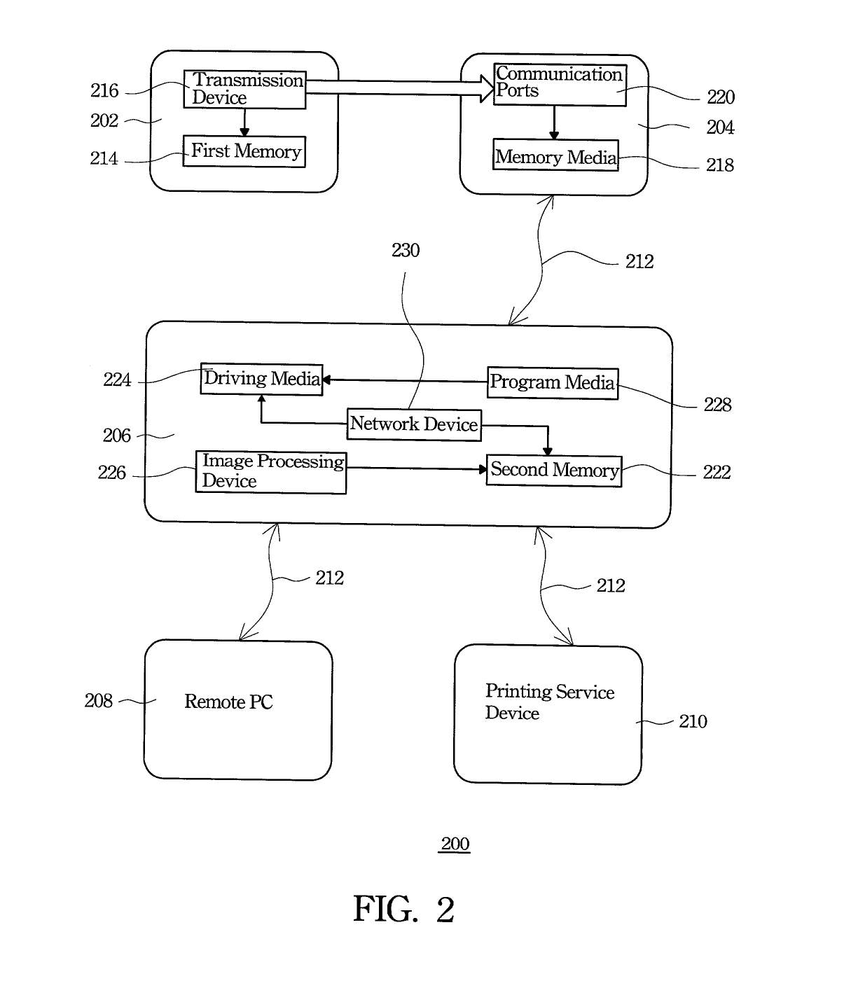

Referring to FIG. 2, a system diagram 200 of a preferred embodiment according to the present invention is illustrated. The image management system comprises a capturing device 202, a local PC 204, an image server 206, a remote PC 208, a printing service device 210, and an Internet network 212.

The capturing device 202 is used for acquiring digital image stored in the first memory 214 of the capturing device 202, and comprises a transmission device 216, e.g. USB, serial port (RS232), small computer system interface (SCSI), and other cable/wireless transmission ports. The capturing device 202 also comprises a digital camera and a PC camera. The local PC 204, coupled to the transmission device 216 via Internet 212, receives the digital image by the communication ports 220 and the digital image temporarily stored in the memory media 218. The local PC 204 also has a communication device (not shown), such as a network interface card (NIC) and a modem used for connecting to the Internet 212.

The image server 206 to the local PC 204 via Internet 212 provides sufficient memory to store the digital image and comprises a CPU (not shown), a second memory 222, a driving media 224, a program media 228, an image processing device 226 and a network device 230. Generally, the CPU is the control center of the image server 206 for the transmission of the digital image. The second memory 222 supplies a sufficient amount of memory for temporary storage to save the digital images. The driving media 224 provides several kinds of drivers responsive to the specific capturing device 202 respectively. The program media 228 is automatically capable of diagnosing the capturing device 202 and then installs the driver to drive the capturing device 202 by Internet 212. Furthermore, the local PC 204 can carry out the driving media 224 and the program media 228 also preferably comprised by Java application. The image-processing device 230 makes the use of the management and distribution of the digital image, for example, classification, editing, copying, removing, previewing and transmitting. The network device 230, such as NIC, a modem and the like, makes the image server 206 instantaneously connect to the Internet 212.

The remote PC 208, coupled to the image server 206 via Internet 212, is used for downloading the digital image. The printing service device 212 can supply the service of printing and developing after the digital image is processed. The Internet devices, e.g. modem, broadband transmission, asymmetric digital subscriber line (ADSL) and the like, connect the above devices to one another.

According to the above-mentioned, a method and system for managing digital images using online driving from a network are disclosed. The image server 206 provides a large amount of memory so as to store digital images. Additionally, the user can easily perform the default management program to distribute the digital image whenever and wherever users can access the Internet 212. It is more beneficial that the image server 206 drives the capturing device 202 online by using a proper driver and the memory of the capturing device 202 has been kept available all the time.

As understood by a person skilled in the art, the foregoing preferred embodiments of the present invention are illustrations rather than limitations of the present invention. It is intended to cover various modifications and similar arrangements included within the spirit and scope of the appended claims, the scope of which should be accorded the broadest interpretation so as to encompass all such modifications and similar structure.

What is claimed is:

1. A method for managing images using online driving from a network, comprises the steps of:
forming a digital image by a capturing device wherein the digital image is stored in a first memory of said capturing device, and a local personal computer (PC) makes a real-time connection to a Internet and receives the digital image;
performing a user authorization check by an image server and then offering an access right to a user for increasing the operation security wherein said image sever has been connected to the Internet;
automatically diagnosing said capturing device by using a program media and then installing a corresponding media driver for online driving said capturing device to increase transmission convenience with respect to said capturing device;
uploading the digital image stored in said first memory to a second memory of said image server, and therefore the capacity of said first memory is completely released; and
editing the digital image stored in said image server by using proper editing software and concurrently storing the digital image-processed in said second memory to promote the efficiency of said first memory and make a management and distribution with respect to the digital image.

2. The method of claim 1, wherein the step of installing said driving media corresponding to said capturing device comprises the process that said driving media is automatically set by said program media.

3. The method of claim 1, wherein the step of installing said driving media corresponding to said capturing device comprises the process that said driving media responsive to said capturing device is manually set by the user.

4. The method of claim 1, wherein said capturing device comprises a digital camera or a PC camera.

5. The method of claim 1, wherein said first memory is the one selected from a group consisting of flash compact cards, smart media cards and floppy disks.

6. The method of claim 1, wherein said program media is the one selected from a group consisting of common gate interface (CGI), active server page (ASP), hypertext markup language (HTML), extensible markup language (XML), Java application programs and the combination of the above.

7. The method of claim 1, wherein said driving media comprises drivers corresponding to all kinds of said capturing device respectively.

8. The method of claim 7, wherein each of said drivers are installed in said image server or said remote PC.

9. The method of claim 1, wherein the user can selectively allocate the size of said second memory according the requirement.

10. The method of claim 1, wherein the step of editing the digital image further comprises the one selected from a group consisting of classification, editing, copying, removing, previewing, transmitting and the combination of the above.

11. The method of claim 1, further comprising providing print or development service to output the digital image to papers after the digital image is edited.

12. The method of claim 1, after digital image is edited, further comprising:
performing login procedures from said remote PC and then being authorized by said image server; and
downloading the digital image stored in said second memory to said remote PC via the Internet.

13. A system for managing images using online driving from a network, comprising:
a capturing device, having a first memory and a transmission device, for acquiring digital images stored in said first memory;
a local PC, coupled to said capturing device and an Internet, for receiving the digital image wherein a communication port of said local PC is connected to the transmission device;
an image server, coupled to said local PC via the Internet, having:
a second memory, for supplying a sufficient amount of memory as temporary storage to save the digital image;
a driving media, for providing a variety of drivers responsive to said capturing device respectively;
a program media, for diagnosing the capturing device and then installing a driver to drive said capturing device by the Internet; and
an image processing device, for editing the digital image of said second memory to perform management and distribution of the digital image; and
a remote PC, coupled to the image server via the Internet, for downloading the digital image.

14. The method of claim 13, wherein said driving media is automatically set by said program media.

15. The method of claim 13, wherein said driving media responsive to said capturing device is manually set by the user.

16. The method of claim 13, wherein said capturing device comprises a digital camera or a PC camera.

17. The method of claim 13, wherein said first memory is the one selected from a group consisting of flash compact cards, smart media cards and floppy disks.

18. The method of claim 13, wherein each of said drivers are installed in said image server or said remote PC.

19. The method of claim 13, further comprising a print or development service device to output the digital image after digital image is completely edited.

20. A system for managing images using online driving from a network and for execution by a computer, comprising:
a capturing device, having a first memory and transmission device, for acquiring digital image stored in said first memory;
an image server, coupled to said capturing device, having:
a second memory, for supplying a sufficient amount of memory as temporary storage to save the digital images;
a driving media, for providing a driver responsive to said capturing device;
a program media, for diagnosing the capturing device and then installing the driver to drive said capturing device by the Internet; and
an image processing device, for editing the digital image of said second memory to perform management and distribution of the digital image; and
a remote PC, coupled to the image server via the Internet, for downloading the digital image.
